(19) United States
(12) Patent Application Publication
(10) Pub. No.: US 2022/0156772 A1
(43) Pub. Date: May 19, 2022

(54) SYSTEMS AND METHODS FOR PROPENSITY-BASED TARGETED MESSAGING

(71) Applicant: The Toronto-Dominion Bank, Toronto (CA)

(72) Inventor: Vipul Kishore LALKA, Oakville (CA)

(73) Assignee: The Toronto-Dominion Bank, Toronto (CA)

(21) Appl. No.: 16/951,598

(22) Filed: Nov. 18, 2020

(51) Int. Cl. G06Q 30/02; G06Q 40/02; H04W 4/029; H04L 12/58

(52) U.S. Cl. CPC G06Q 30/0205; G06Q 30/0201; G06Q 50/16; H04W 4/029; H04L 51/20; G06Q 40/025

(57) ABSTRACT

Servers, systems, and methods for targeting messages to users based on a propensity score. The propensity score is determined based on geolocation data. A visit to a monitored location is determined based on geolocation data from a mobile device associated with a user. Occurrence of an activity associated with the monitored location is detection based on geolocation data from the mobile device. The propensity score is determined or adjusted based on the visit and the activity detected and a targeted message is sent to the mobile device based on the propensity score exceeding a threshold value. The location may be a car dealership and the activity may be occurrence of a test drive, in some implementations.

### TECHNICAL FIELD

The present application relates to targeted messaging and, in particular, to systems and methods that generate and send targeted messages based on determining geolocation and propensity.

### BACKGROUND

Systems that send messages to mobile devices providing product or service information or offers tend to result in a large number of unwanted and wasteful messages that are ignored or deleted by users. This can result in annoyance of users that feel “spammed” with irrelevant messaging, and results in waste of both processing and bandwidth resources. It would be advantageous to provide for systems and methods that provide improved targeting of messages to users.

### BRIEF DESCRIPTION OF THE DRAWINGS

Embodiments are described in detail below, with reference to the following drawings:

FIG. 1 is a simplified diagram of an example system for generating targeted messages;

FIG. 2 is high-level schematic diagram of a computing device;

FIG. 3 shows a simplified organization of software components stored in a memory of the computing device of FIG. 2;

FIG. 4 shows, in flowchart form, an example method for generating targeted messages;

FIG. 5 shows, in flowchart form, an example method for detecting an activity based on geolocation data;

FIG. 6 shows, in flowchart form, another example method for generating targeted messages; and

FIG. 7 shows, in flowchart form, one example method of generating targeted messages relating to automobile purchase or insurance.

Like reference numerals are used in the drawings to denote like elements and features.

### DETAILED DESCRIPTION OF VARIOUS EMBODIMENTS

In one aspect, the present application describes a server for targeted messaging. The server may include a network connection; a processor coupled to the network connection; and memory coupled to the processor and storing processor-executable instructions. When executed by the processor, the processor-executable instructions may cause the processor to receive, via the network connection, geolocation data from a mobile device representing location of the mobile device over a time window; determine, from the geolocation data, that the mobile device visited a monitored location; detect occurrence of an activity at the monitored location based on the geolocation data; determine, based on the activity, a propensity score associated with the mobile device and the monitored location; determine, based on the propensity score, a message associated with the monitored location; and send, via the network connection, the message to the mobile device.

In some implementations, the activity may be detected based on a time determined between a departure from the monitored location and a return to the monitored location. In some such cases, the activity is detected further based on velocity data obtained from the geolocation data between the departure and the return.

In some cases, the activity is detected further based on an arrival at the monitored location prior to the departure, the departure and the return occurring within less than a threshold time, and a further departure from the monitored location. The activity may be detected further based on identification, from the geolocation data, of a second departure and a second return occurring between the arrival and the further departure.

In some implementations, the instructions, when executed, may cause the processor to determine the propensity score by further determining a count of visits to the monitored location.

In some implementations, the instructions, when executed, may cause the processor to determine the propensity score by further determining a count of visits to locations in a same class as the monitored location.

In some implementations, the monitored location includes a car dealership and the activity includes a test drive.

In some implementations, the server further includes a data store that includes user data, and the mobile device may be associated with a registered user, and the instructions, when executed, may cause the processor to obtain stored user data from the data store associated with the registered user and to determine the propensity score based on the activity and the stored user data. In some cases, the stored user data includes financial data associated with the registered user.

In another aspect, the present application describes a method of targeted messaging. The method may include receiving geolocation data from a mobile device representing location of the mobile device over a time window; determining, from the geolocation data, that the mobile device visited a monitored location; detecting occurrence of an activity at the monitored location based on the geolocation data; determining, based on the activity, a propensity score associated with the mobile device and the monitored location; determining, based on the propensity score, a message associated with the monitored location; and sending the message to the mobile device.

Other aspects and features of the present application will be understood by those of ordinary skill in the art from a review of the following description of examples in conjunction with the accompanying figures.

In the present application, the term “and/or” is intended to cover all possible combinations and sub-combinations of the listed elements, including any one of the listed elements alone, any sub-combination, or all of the elements, and without necessarily excluding additional elements.

In the present application, the phrase “at least one of . . . or . . . ” is intended to cover any one or more of the listed elements, including any one of the listed elements alone, any sub-combination, or all of the elements, without necessarily excluding any additional elements, and without necessarily requiring all of the elements.

Example embodiments of the present application are not limited to any particular operating system, system architecture, mobile device architecture, server architecture, or computer programming language.

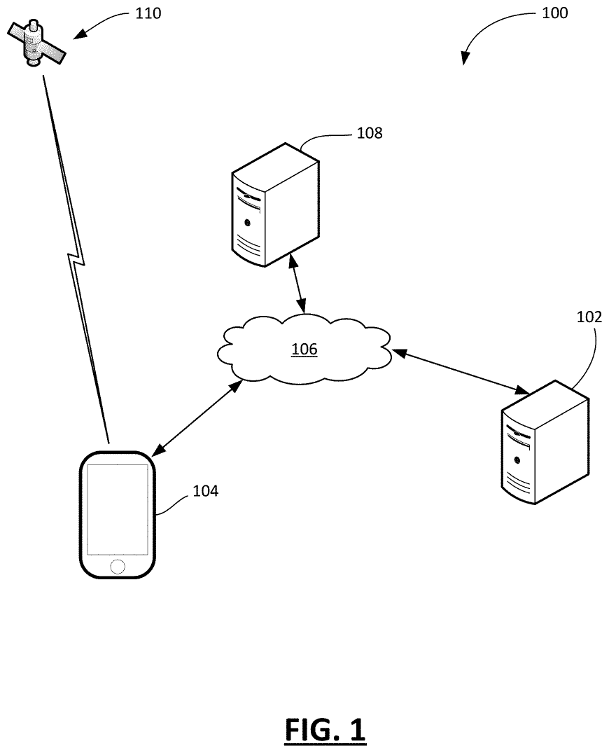

FIG. 1 is a schematic diagram illustrating an example system 100 for generating targeted messages. A server 102 and a remote wireless mobile device 104 communicate over a network 106. The remote wireless mobile device 104 may take a variety of forms, such as a smart phone, a tablet, a laptop, or other mobile computing devices. The server 102 may be implemented using a variety of computing devices, which may include a suitably-programmed general purpose computing device. In some cases, the server 102 includes a plurality of computing devices. In some implementations, the server 102 is associated with a financial services enterprise, such as a bank, credit union, credit card company, etc.

The mobile device 104 may include a geolocation function, such as a Global Navigation Satellite System (GNSS) chip. Examples of GNSS include the Global Positioning System (GPS), the BeiDou Navigation System (BDS), and the Galileo system. The mobile device 104 may receive broadcast GNSS signals from a plurality of satellites 110, from which the GNSS chip may determine the terrestrial location of the mobile device 104.

In some cases, the mobile device 104 also or alternative includes a non-satellite based geolocation function. One example relies on cellular tower signals and IDs. Another example relies on WiFi signals and IDs. Other techniques for geolocation may also be used for some implementations.

The mobile device 104 may be configured to transmit geolocation data to the server 102 over the network 106. The geolocation data may be sent periodically, in response to detection of a trigger event at the mobile device 104, such as detection of more than a threshold change in location or identification of a geofence boundary event, or in reply to a polling message from the server 102. The mobile device 104 may be configured to transmit the geolocation data to the server 102 based on enrolment of the mobile device 104 as a registered device with the server 102.

In one example implementation, the server 102 is associated with a financial institution and a registered user of the financial institution operates the mobile device 104. The registered user may have one or more accounts with the financial institution, such as a bank account, line of credit, credit card, credit facility, investment account, or the like. Accordingly, the server 102 may have a user record stored in a data store and containing details of the registered user and the registered user's associated accounts. The details regarding the registered user may include contact details, such as a name, username, phone number, email address, social media handle, etc. The user record may further include data regarding the mobile device 104, which may include a phone number, an international mobile subscriber identity (IMSI), a device identifier, MAC address, etc. The user record may further include ephemeral data regarding the mobile device 104, such as an IP address or the like.

The mobile device 104 may have installed thereon an application or other software module configured to relay geolocation data to the server 102. In some examples, the application may be a mobile app associated with the financial institution, e.g. a banking app, through which the mobile device 104 may access data stored on the server 102 regarding the registered user's accounts, balances, etc., subject to verification and authentication prerequisites. The banking app may enable the performance of transfers, purchases, divestments, or other such operations. The banking app may further be configured to relay geolocation data from the mobile device 104 to the server 102.

The geolocation data may be used by the server 102 to determine when the mobile device 104 enters or is proximate to a location of interest. Locations of interest may be specific locations, or classes of locations. Locations of interest may be those locations associated with a potential future event. As an example, a location of interest may be a car dealership, which is associated with a potential future car purchase event. Another location of interest may be a real estate open house, which may be associated with a potential house purchase and/or sale. Either such event may be associated with a future credit or financing event.

The server 102 may be configured to identify locations of interest based on map data stored locally or obtained from a third party data source 108, such as a server or a data service to which the server 102 may subscribe to obtain location data. In the case of car dealerships, the locations of interest may be identified based on searches of map data and/or directory listings and/or dealership associations, for example. The location of car dealerships may be relatively static and may be determined once and updated somewhat infrequently. In some cases, the locations of interest may vary more quickly over time. For example, open houses may change frequently. The locations of open houses may be identified based on a data feed from an open or proprietary multiple listing service, such as an MLS service. In some cases, the locations of open houses may be based on automated searches (e.g. crawlers and/or scrapers) of real estate websites, for example.

Irrespective of the data source(s) and technique, the server 102 obtains data regarding locations of interest. The server 102 may then identifier whether the mobile device 104's geolocation data indicates that the mobile device 104 is at a location of interest. In some cases, the locations of interest may referred to herein as “monitored locations”, in the sense that server 102 assesses whether geolocation data matches the geolocation of one of the monitored locations.

The server 102 may be configured to send a targeted message to a mobile device 104 based on the mobile device 104 visiting one of the monitored locations. For example, if the location of interest is a car dealership, the server 102 may be configured to send a message containing information regarding auto loans or lease financing. In some cases, the message may be customized to present the mobile device 104 with an offer generated based, in part, on the user data associated with the mobile device 104, e.g. based on a credit score or other creditworthiness measure for the registered user.

Targeting messaging of this nature that sends messaging to a mobile device based solely on geolocation is likely to be over-inclusive and result in sending messages to unreceptive users. That is, too many messages may be generated and that have little relevance to the recipient and will be ignored or deleted. In the worst case, the messaging may provoke a negative association or reaction from the user due to the user feeling spammed by irrelevant messaging. Excess unnecessary messages result in unwarranted and wasteful consumption of processing resources and wireless bandwidth. It would be advantageous to improve the targeting of messages that relies on geolocation.

In accordance with one aspect of the present application, the targeting of messages is carried out by detecting occurrence of an activity at the monitored location and, based at least in part on that activity, determining a propensity score. The propensity score may be a measure of likely relevance of a message to the user. If the propensity score exceeds a threshold value, in some cases, a message may be send to the associated mobile device 104. The propensity score may be used to generate the content of the message in some cases. In some instances, the propensity score may be used together with user data regarding the associated registered user to generate the message content.

The activity may be detected from data provided by the mobile device. The data may be geolocation data from which the activity may be identified or detected. In another example, the data may be sensor data from the mobile device. As an example, use of the camera to capture photos or video may be detected as an activity.

By detecting an activity, it may be possible for the server 102 to distinguish between a visit to a location of interest that is correlated to a potential future event for which the message content could be relevant, and a visit that is unrelated to the potential future event. As an illustrative example, a user may visit a car dealership because that user is seriously contemplating the purchase or lease of a new or used vehicle. On the other hand, a user may visit a car dealership because the user is having an existing vehicle serviced by a service department at the dealership. Likewise, a user may visit an open house because he or she is actively and seriously considering a home purchase, or the user may visit an open house because he or she is simply curious about a house and has no intention of buying. Similarly, a user may visit a house that is for sale because the user is a prospective purchase, or the user may visit a house that is for sale because he or she is a friend of the owner.

Geolocation data may assist in detecting activity correlated to a “more serious” visit to a monitored location, in terms of it being more likely associated with a particular potential future event, e.g. purchase or lease activity. Accordingly, targeted messaging may be at least partly based on detection of the activity. Detection of the activity may be a factor in determining a propensity score.

In one example, the activity may be a “test drive” at a car dealership. Detection of that activity may be inferred from geolocation data. For example, if the mobile device 104 arrives at the car dealership, then departs the car dealership and returns within a certain window of time, the geolocation data may correlate to a test drive. The speed of the mobile device 104 between departure and return may further be evaluated from the geolocation data, which may be indicative of vehicular travel.

In another example, the activity may be visiting two or more monitored locations, whether car dealerships or open houses, within a certain window of time. A user that visits multiple monitored locations in the same class is more likely to be actively shopping than a user that makes a casual opportunistic decision to look at an open house or a car dealership. In some cases, returning to the same monitored location within a window of time may be a detected activity.

The activity or activities detected based on geolocation data may be a factor in determining a propensity score. The propensity score may be further based on user data, e.g. in the case of a financial institution the user data may indicate a recent increase in bank account balance, deposits, or other factors indicating a new or increased source of funds that could motivate a larger purchase, or the creditworthiness of the user data may make it unlikely that the user is seriously contemplating a large purchase given the user's limited resources. The propensity score may be further based on historical activity data; for example, a count of visits to monitored locations of the same class in the past week or month. The propensity score may be further based on other data transmitted from the mobile device 104 to the server 102, such as use of a mobile device 104 camera while at the monitored location on the basis that user that takes pictures while at the car dealership and/or open house (to use those examples) may be more seriously considering a purchase. Other mobile device 104 activity may also be correlated to a higher propensity score or, conversely, a lower propensity score.

The propensity score may be used as a filter. That is, in some implementations, only when the propensity score exceeds a threshold value is a message generated and sent. In some implementations, the propensity score may also or alternatively be used to select the content of the message. A user with a higher propensity score may be sent a different offer than a user with a lower propensity score.

The message is transmitted from the server 102 to the mobile device 104 over the network 106. The message may be in the form of a text message, email, social media message, app notification, or in any other such form.

The network 106 may be formed of one or more interconnected computer networks. For example, the network 106 may be or may include an Ethernet network, an asynchronous transfer mode (ATM) network, a wireless wide area network (WWAN), a wireless local area network (WLAN), or the like. The network 106 may, in some embodiments, include a plurality of distinct networks. For example, communications between certain of the computer devices may be over a private network whereas communications between other of the computer devices may be over a public network, such as the Internet. In some cases, communications may use both private and public networks for different legs of a communication path. Various authentication, encryption, and other privacy-protection measures may be employed to secure the communications and prevent fraudulent or malicious communications.

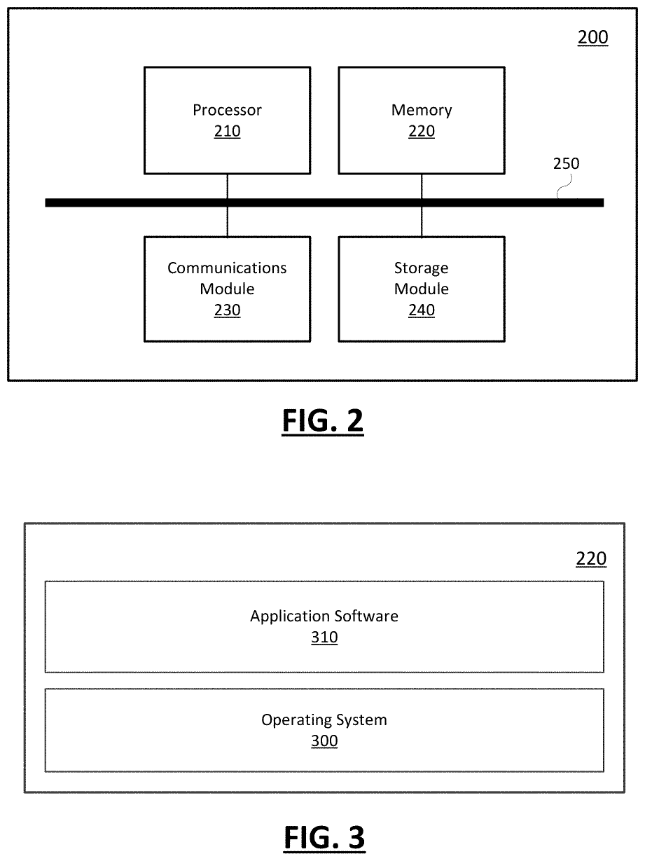

Referring now to FIG. 2, a high-level operation diagram of an example computing device 200 will now be described. The example computing device 200 may be exemplary of the server 102 or the mobile device 104.

The example computing device 200 includes numerous different modules. For example, as illustrated, the example computing device 200 may include a processor 210, a memory 220, a communications module 230, and/or a storage module 240. As illustrated, the foregoing example modules of the example computing device 200 are in communication over a bus 250.

The processor 210 is a hardware processor. The processor 210 may, for example, be one or more ARM, Intel x86, PowerPC processors or the like.

The memory 220 allows data to be stored and retrieved. The memory 220 may include, for example, random access memory, read-only memory, and persistent storage. Persistent storage may be, for example, flash memory, a solid-state drive or the like. Read-only memory and persistent storage are a non-transitory computer-readable storage medium. A computer-readable medium may be organized using a file system such as may be administered by an operating system governing overall operation of the example computing device 200.

The communications module 230 allows the example computing device 200 to communicate with other computing devices and/or various communications networks. For example, the communications module 230 may allow the example computing device 200 to send or receive communications signals. Communications signals may be sent or received according to one or more protocols or according to one or more standards. For example, the communications module 230 may allow the example computing device 200 to communicate via a cellular data network, such as for example, according to one or more standards such as, for example, Global System for Mobile Communications (GSM), Code Division Multiple Access (CDMA), Evolution Data Optimized (EVDO), Long-term Evolution (LTE) or the like. Additionally, or alternatively, the communications module 230 may allow the example computing device 200 to communicate using near-field communication (NFC), via WiFi™, using Bluetooth™, or via some combination of one or more networks or protocols. In some embodiments, all or a portion of the communications module 230 may be integrated into a component of the example computing device 200. For example, the communications module 230 may be integrated into a communications chipset.

The storage module 240 allows the example computing device 200 to store and retrieve data. In some embodiments, the storage module 240 may be formed as a part of the memory 220 and/or may be used to access all or a portion of the memory 220. Additionally, or alternatively, the storage module 240 may be used to store and retrieve data from persisted storage other than the persisted storage (if any) accessible via the memory 220. In some embodiments, the storage module 240 may be used to store and retrieve data in a database. A database may be stored in persisted storage. Additionally, or alternatively, the storage module 240 may access data stored remotely such as, for example, as may be accessed using a WLAN, WWAN, personal area network (PAN), and/or a storage area network (SAN). In some embodiments, the storage module 240 may access data stored remotely using the communications module 230. In some embodiments, the storage module 240 may be omitted and its function may be performed by the memory 220 and/or by the processor 210 in concert with the communications module 230 such as, for example, if data is stored remotely. The storage module may also be referred to as a data store.

Software comprising instructions is executed by the processor 210 from a computer-readable medium. For example, software may be loaded into random-access memory from persistent storage of the memory 220. Additionally, or alternatively, instructions may be executed by the processor 210 directly from read-only memory of the memory 220.

The computing device 200 will include other components apart from those illustrated in FIG. 2 and the specific component set may differ based on whether the computing device 200 is operating as the server 102 or the mobile device 104. For example, the computing device 200 may include one or more input modules, which may be in communication with the processor 210 (e.g., over the bus 250). The input modules may take various forms including, for example, a mouse, a microphone, a camera, a touchscreen overlay, a button, a sensor, etc. By way of further example, the computing devices 200 may include one or more output modules, which may be in communication with the processor 210 (e.g., over the bus 250). The output modules include one or more display modules which may be of various types including, for example, liquid crystal displays (LCD), light emitting diode displays (LED), cathode ray tube (CRT) displays, etc. By way of further example, the output modules may include a speaker.

FIG. 3 depicts a simplified organization of software components stored in the memory 220 of the example computing device 200 (FIG. 2). As illustrated, these software components include an operating system 300 and an application software 310.

The operating system 300 is software. The operating system 300 allows the application software 310 to access the processor 210 (FIG. 2), the memory 220, and the communications module 230 of the example computing device 200 (FIG. 2). The operating system 300 may be, for example, Google™ Android™, Apple™ iOS™, UNIX™, Linux™ Microsoft™ WindOWS™, Apple OSX™ or the like.

The application software 310 adapts the example computing device 200, in combination with the operating system 300, to operate as a device performing a particular function. For example, the application software 310 may cooperate with the operating system 300 to adapt a suitable embodiment of the example computing device 200 to operate as the server 102 or the mobile device 104.

While a single application software 310 is illustrated in FIG. 3, in operation the memory 220 may include more than one application software 310 and different application software 310 may perform different operations.

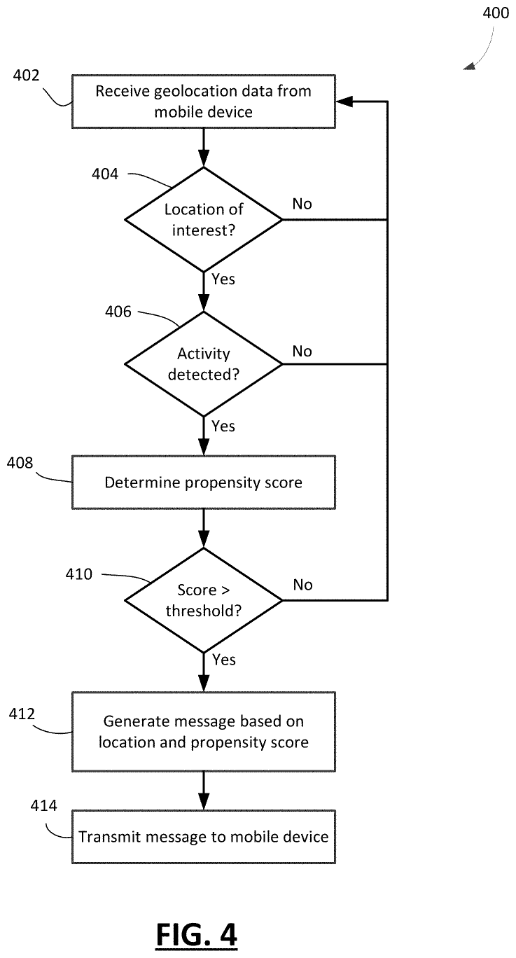

Reference is now made to FIG. 4, which shows, in flowchart form, an example method 400 for targeted messaging. The example method 400 may be implemented using software stored at the server 102 in some examples. The software may include processor-executable instructions that, when executed, cause one or more processors in the server 102 to carry out the described operations. In some cases the instructions may cause the processor(s) to command or instruct other components of the server 102 so as to cause those components to carry out a described operation.

The method 400 includes receiving geolocation data from a remote mobile device over a computer network in operation 402. The remote mobile device may be a smartphone, tablet, laptop, or the like. The geolocation data may be received in a communication that includes identifying information for the mobile device and/or an associated registered user. The registered user and/or the mobile device may be linked to a user record at the server. In the example of a financial institution, the user record may include a customer record that details the customer's identity, contact information, financial data, account(s) details, credit scores, etc. In some cases, the customer record may further include historical customer information, such as information regarding past financial transactions or patterns, a history of credits/debits to one or more accounts, survey data obtained from the customer, a history of responses/non-responses to past offers or incentive programs, loyalty program data, or the like.

The geolocation data may include one or more coordinate solutions determined by a GNSS chip within the mobile device based on satellite signals. In some cases, the geolocation data may include one or more velocity values determined by the GNSS chip within the mobile device. In some cases, the geolocation data may include coordinate data determined by the mobile device other than from GNSS signals. For example, the coordinate data may be based on cellular tower triangulation, or other such sources of positional data. The geolocation data may be time stamped and may include more than one set of readings determined over a time period.

In operation 404, the server determines from the geolocation data whether the mobile device is at a location of interest, i.e. at a monitored location. The locations of interest or monitored locations are those geographical locations that were identified by the server as being within a class of monitored locations. Examples include “car dealerships”, “real estate open houses”, “condominium sales offices”, “boat dealerships”, or the like. The present application is not necessarily limited to such examples.

Once the server identifies from the geolocation data that the mobile device is at a monitored location, then in operation 406 it assesses whether an activity is detected. The activity may be detected from the geolocation data received from the mobile device. The activity may be inferred from the geolocation data. The activity may be one correlated to a higher interest in a potential future event, such as a purchase event. Such activities may include repeated return visits to the location, multiple visits to the same class of location within a window of time, or movement indicative of a test drive or other such ‘evaluation’ activity correlated to a higher interest level. Such activities may also aid in excluding false positive visits. For example, a visitor to a car dealership may be bringing an existing car in for servicing rather than contemplating a new car. Such a visitor is not likely to engage in a test drive activity.

Detecting the activity may be partly based on a count of visits to the location or class of locations, the time between visits, and/or the duration of each visit. In the example of a “test drive”, detecting the activity may include detecting that the mobile device leaves the location and returns to the location within a threshold period of time sufficiently short to indicate a test drive. For example, the threshold may be half an hour, twenty minutes, or the like. Detecting may further include determining that the mobile device velocity during at least a portion of the time between leaving and returning is indicative of vehicular travel. Detecting may further include determining that the mobile device travel sufficiently corresponds to a geographical pattern associated with the monitored location, e.g. where test drives tend to follow one or two common patterns.

In another example, detecting the activity may be based on sensor data sent to the server by the mobile device. The sensor data may include, for example, use of the camera sensor during the visit to capture photos or video. When visiting a car dealership or open house the capture of photos/videos may make it more likely that the user is serious about the potential purchase. Note that photo/video activity may be less relevant for detecting an activity with respect to a house listed for sale (as opposed to a listed house during an open house time) since the user may be visiting the house occupant/owner and may be using the camera in the normal course.

In this example, once the activity is detected in operation 406, the server then determines a propensity score in operation 408. That is, determination of the propensity score is based on first detecting the activity. However, in other example implementations, the propensity score may be determined taking into account other factors irrespective of whether the activity is detected, and the detected activity is simply an additional factor in determining the propensity score.

The propensity score may be partly or wholly based on detection of the activity. In some embodiments, the propensity score is based on detection of the activity and one or more other factors. Other factors may include number of visits to locations in the same class of location (e.g. other car dealerships) in the same day or week or month, number of return visits to this monitored location, average duration of the visits, distance travelled by the mobile device from a home location to visit the monitored location. The propensity score may further be based on user data, such as the user's financial data and/or creditworthiness in some cases. The propensity score may further be based on historical user data, such as user responsiveness to prior offers or incentive programs.

In operation 410, the server determines whether the propensity score is sufficiently high to justify sending a message to the mobile device. If not, then the server continues to monitor the mobile device location and update the propensity score in operations 402-408. If the score is sufficiently high, then in operation 412 a message is generated by the server. In some example implementations, the propensity score is used to determine the content of the message instead of whether the user will receive the message. By detecting the activity having occurred, the server has already detected an indicator of a sufficiently interested user, meaning that a message will always be sent; however, the propensity score may be used to determine the content of that message.

In operation 412, the message is generated. The message is generated based on the location or class of location, e.g. if the class is “car dealership”, then the message may be generated to offer information on car loans, financing terms, lines of credit, auto insurance, or the like. If the class is “open house”, then the message may be generated to offer information regarding mortgage rates, prequalification criteria, mortgage incentive programs, home insurance, or the like.

The message may further be generated based on the propensity score. That is, the propensity score may be used as the basis, at least in part, for determining an offer. The offer may be varied based on the propensity score's indication of the likely level of user interest. For example, a higher propensity score, which may correlate to a higher likelihood of purchase, may result in an improved offer, e.g. lower financing rate, larger cash-back incentive, preferred options, etc., on the basis that the improved offer is more likely to lead to a completed purchase event. Conversely, in some implementations, a higher propensity score may be the basis for including a lower offer, e.g. less advantageous terms or conditions, on the basis that the purchase event is already more likely to occur so improved incentives may not be needed to motivate the user.

It will also be appreciated that the message may be further based on user eligibility criteria and the user data stored at the server. That is, the user data may be evaluated to assess creditworthiness and eligibility for any offers or incentives. In some cases, user data may the basis for determining that some offers or incentives are not available and cannot be included in the message due to minimum user eligibility criteria.

In operation 414, the server transmits the message to the mobile device. As noted above, the message may be in the form of a text message, an email, a social media direct message, a push notification, an app notification, or the like. The message may be a data message to the mobile device which the mobile device displays on its display. The data message may be displayed on the mobile device within a messaging application, social media application, mailbox application, banking application, insurance application, or other such application, or as a notification via the operating system of the mobile device.

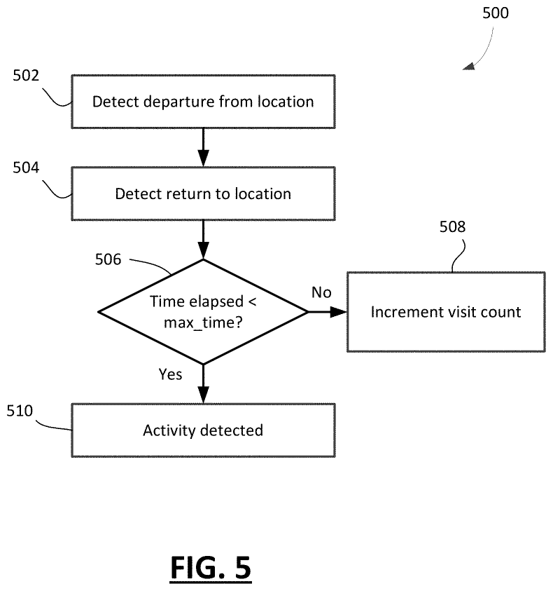

FIG. 5 shows, in flowchart form, one example method 500 for detecting an activity based on geolocation data. The method 500 may be carried out in connection with a geolocation monitoring method for targeting messages, such as that described in connection with FIG. 4, for example. In this method 500, the server has received geolocation data that indicates the mobile device is at a monitored location. In operation 502, the server determines from further received geolocation data that the mobile device has departed from the monitored location. The geolocation data may include a time series of coordinate locations, velocity data, raw satellite signal data, or any other geolocation-related data from which the geographical position of the mobile device over time may be identified.

After detecting departure of the mobile device, in operation 504 the server identifies return of the mobile device to the monitored location. The return of the mobile device is identified based on further geolocation data received from the mobile device.

In operation 506, the server determines the time elapsed between the departure and the return and compares it to a maximum time value. If the time elapsed is less than the maximum time value, then in operation 510 the server determines that an activity has been detected. In one example, return to the monitored location within the maximum time value is indicative of a test drive activity. The maximum time value may be set to any suitable value, such as 20, 30, or 40 minutes for example.

If the time elapsed is not less than the maximum time value, then in operation 508 the server may increment a discrete visit count. That is, in some implementations, the return to the monitored location may be classified as a return visit rather than return from a test drive activity.

Other factors may be used in the activity detection of operation 510. For example, velocity reports from the mobile device, geolocation tracking during travel between departure and return, or other such factors. It will be appreciated that the method 500 for activity detection is particularly applicable to detection of a travel-related activity due to reliance on geolocation data. Test drives from a car dealership are one such example.

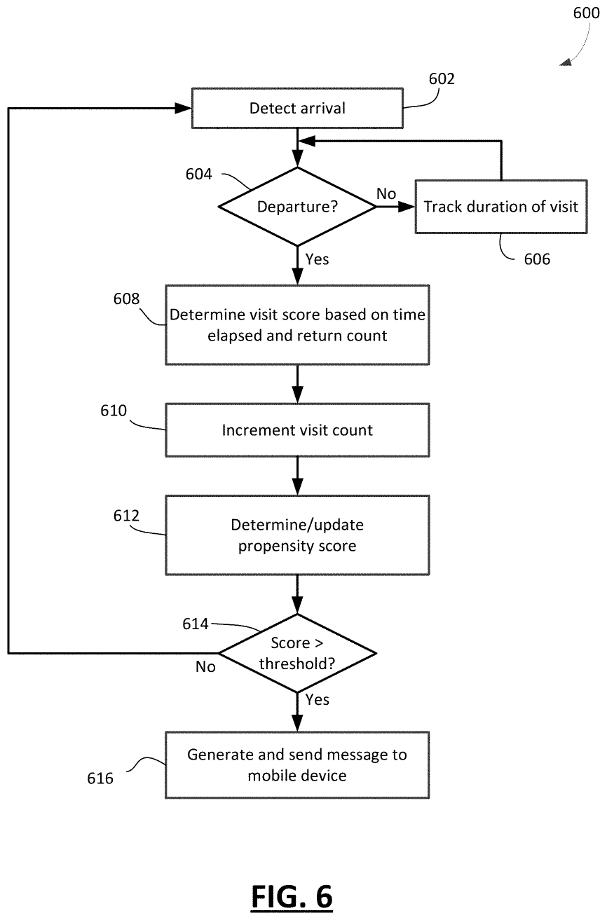

FIG. 6 shows, in flowchart form, a further example method 600 for targeting messages.

The method 600 includes detecting, based on received geolocation data, arrival of the mobile device at a monitored location in operation 602. As indicated by operations 604 and 606, the server continues to track the duration of the visit until the mobile device is detected departing the monitored location.

In operation 608, after detecting departure, the server determines a visit score based, in part, on the duration of the visit and a count of visits to this location. Other factors may include a length of time between this visit and the previous visit to this location. A visit count may be incremented in operation 610.

The propensity score may then be updated in operation 612. The propensity score may be updated based on the visit score determined in operation 608. The propensity score may be a numerical assessment of the likelihood of a future action, such as a car purchase, and may be tracked over time based on a number of inputs including visit scores associated with visits to the monitored location, to other monitored locations in the same class of location (e.g. other car dealerships), or other non-geolocation based factors, such as financial user data. The visit score determined in operation 608 may further be based on whether an activity was detected at the location, such as test drive or another geolocation-based detected activity.

If the updated propensity score is greater than a threshold value in operation 614, then a message is selected and sent in operation 616. Otherwise, the method 600 continues the next time an arrival is detected at a monitored location. The arrival detected at the monitored location in operation 602 may be a return to the same location within a window of time that may be inferred to be representative of a particular activity, such as a test drive. In such a case, the activity is logged as having been detected and is factored into calculation of the visit score in operation 608, which is a factor in determining the propensity score update in operation 612.

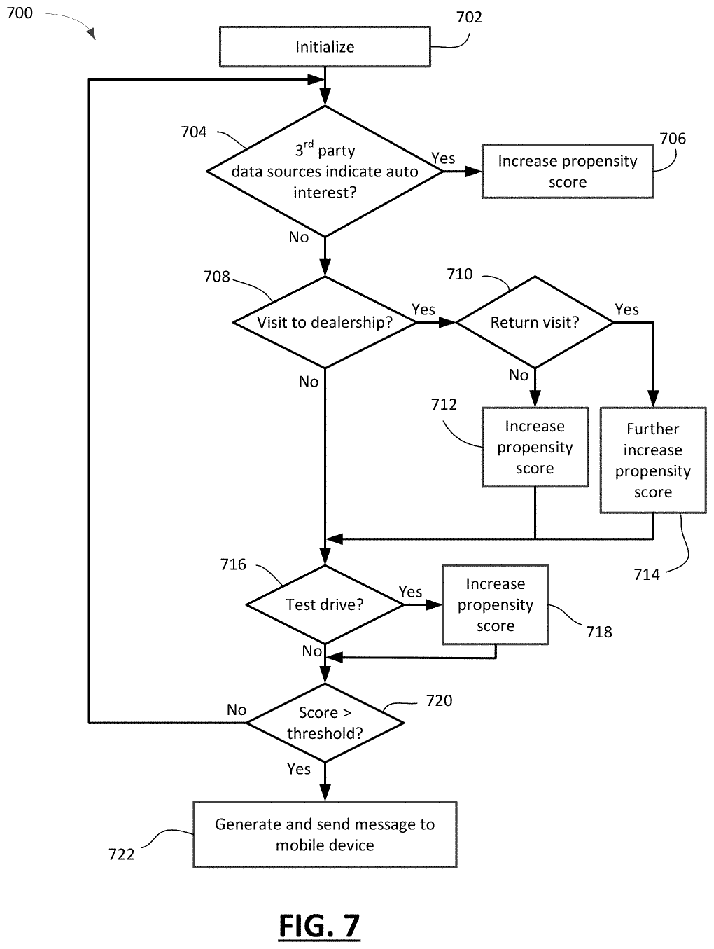

FIG. 7 will now be described. It illustrates, in flowchart form, one example method 700 for targeted messaging in the context of automobile purchase or insurance. The method 700 relates to tracking and updating a propensity score associated with a particular registered user. The method 700 may be implemented by one or more servers that receive geolocation data from a mobile device associated with the registered user.

In operation 702, initialization operations are carried out. This may include determining, from stored user data, whether the user would qualify for any financing, leasing, or other operations by meeting a baseline creditworthiness level. If the user data does not indicate that the user meets a baseline level of creditworthiness, such that the user would not qualify for credit products in any event, then there would be no need to track propensity scores or transmit messages regarding credit offers or the like. The initialization may also, in some implementations, assess whether the user data and/or third party data (as described below) indicates at least a threshold level of interest in automobile purchasing or leasing. This assessment may be based on user data, third party data, or a trigger event. Trigger events may include, for example, a visit to an automobile financing section of the financial institutions website or mobile app, liking or clicking a link on a message or notification from the financial institution relating to automobiles or automobile financing or insurance. Trigger events may further include, for example, user data that indicate a milestone event that may correlate to vehicle purchase, such as a significant birthday, a child turning sixteen, an increase in income or a large lump sum deposited to a financial account, etc.

Assuming that the user data indicates that a threshold level of creditworthiness is met by the user and/or a trigger event or threshold level of interest is determined, then the server may determine an initial propensity score for the user from the user data in operation 702. The user data may list current assets in some cases, such as in data gathered by the server during a previous finance qualification operation, or the user data may have information from which asset ownership may be inferred. For instance, a financial disclosure form may indicate whether the user owns a home, one or more vehicles, etc., which may be used to calculated an initial propensity score. Ownership or an ownership interest may also be inferred from insurance holdings, such as vehicle insurance, home insurance, renter's insurance, etc. The value of the home and its location may correlate to vehicle ownership propensity. Highly urban locations, such as condominiums in dense large cities, may have a lower correlation to vehicle ownership. If the user already owns a vehicle, the propensity to acquire a second vehicle may depend on family status data obtained from the user data and, if available, vehicle ownership data associated with any spouse or partner indicated in the user data. In some cases, ownership of multiple vehicles may indicate a higher likelihood of vehicle purchase, to the extent that the ownership history is indicative of a vehicle aficionado or collector. In some cases, user data history may indicate the frequency with which the user changes vehicles, which may impact an initial propensity score. A user that has only ever owned one vehicle at a time and tends to keep that vehicle for ten years at a time will typically have a lower propensity score than a user that tends to change vehicles every 2 to 3 years. If available, such as from insurance data, the age of the current vehicle may further be a factor in determining the propensity score. To the extent that the user data provide detailed expenditure data, such as from credit card records, expenditures on auto repair may further be used as a factor in determining a propensity score, as a vehicle that has required more frequent repairs in the past 12 to 24 months may be ripe for replacement.

Accordingly the method 700 involves first establishing an initial propensity score based on whatever user data is available to the server in operation 702. This data may further indicate the user's home and work locations, which may be factors in updating the propensity score when assessing geolocation data reported by the user's mobile device. The remainder of the method 700 involves receiving and assessing geolocation data from the mobile device in order to detect visits to car dealerships and test drives, and then making subsequent updates to the propensity score. If the propensity score reaches a certain threshold, then a message may be sent. Multiple thresholds may be established and associated with escalating messages, e.g. an initial message that is more exploratory and informational, and later messages that provide more concrete and specific vehicle purchase financing offers.

In this example, the server also obtains data from a third party data source regarding online activity associate with the user and/or their mobile device. This data may be obtained directly from a third party website or may be reported to the server by the mobile device, perhaps together with the geolocation data. The online activity data may include, for example, data regarding web browser activity, web search terms, social media messages, social media searches, social media share or likes, etc. The data may be pre-filtered before being obtained by the server to be limited to data related to automobiles or automobile purchasing or leasing. In some cases, the server may filter the data to identify whether any of it relates to automobiles or automobile purchasing or leasing. As an example, the data may indicate whether the user has visited dealership websites, user car listing websites (e.g. autotrader.com), car review website, social media posts relating to automobiles, etc., and with what frequency.

The third party data may, if relevant to automobiles, be used to update the propensity score in operation 706.

The server further determines, from the reported geolocation data, whether the user has visited a dealership, as indicated by operation 708. The server may compared reported geolocation data to geolocation data for known locations of dealerships to determine whether a visit has occurred. The geolocation data may further indicate the duration of the visit and a distance from the user's home or work location to the dealership. The farther the user traveled to visit a dealership, the more it may increase the propensity score on the basis that a greater effort and investment of time may indicate a higher propensity to purchase than a casual “kicking-tires” visit to a local dealership to window shop.

In operation 710, the server may assess, from the user geolocation history, whether this is a return visit. The initial visit may have prompted an increase in the propensity score of a certain amount. A return visit to the same dealership within a certain window of time, which may a sliding weighted window, may result in a more significant increase in the propensity score. The window of time may be about a month or more. In some cases, the significance of the return visit is linearly weighted based on the time since the previous visit, where a more recent visit (e.g. within a day or two) results in a heavy weighting, but long time between visits (e.g. two or more months) significantly reduces the weighting attributable to the fact the visit is a “return” visit. In operation 712 or operation 714, the propensity score is adjusted accordingly.

The server further assesses whether the geolocation data indicates detection of an activity, such as a test drive, in association with the car dealership visit, as indicated by operation 716. As noted above, a number of geolocation and time factors may be used in identifying a test drive activity. If one is identifier, then the propensity score is adjusted accordingly as indicated by operation 718.

If the propensity score is greater than a threshold level, as determined in operation 720, then the server generates and transmits a message to the mobile device in operation 722. The message may be generated based, in part, on the propensity score. A propensity score that reaches a first threshold may result in a first category of message, such as one providing general auto finance/insurance product information. A propensity score that reaches a second threshold may result in a second category of message, such as one that provides an auto finance/insurance product offer. A propensity score that reaches a third threshold may result in a third category of message, such as one that provides a link or chat function to connect the user to an agent to facilitate purchase of the auto finance/insurance product, or that provides greater incentive (discount, credits, cash back, etc.) to accept the offered product. In some cases, the message may be timed based on geolocation to be sent when the user is sufficiently proximate a financial institution location to prompt the user to visit to finalize purchase of the auto finance/insurance product.

The escalation of messaging may be based on the ongoing geolocation monitoring of the user's mobile device and the consequent propensity score adjustments made as described in FIG. 7. It will be understood that after operation 722, the method 700 may continue at operation 704 to continue updating the propensity score based on any new data received from third party sources or from the mobile device. In some cases, however, the method 700 may end after sending the message in operation 722.

Although not illustrated, the method 700 may apply a decay operation in which the propensity score is reduced over time. In this manner, activity by the user through online activity, visiting dealerships, taking test drives, etc., increases the propensity score, but the absence of detected activity over time reduces the propensity score. The decay operation may reduce the propensity score to a point where the server determines that the user is sufficiently unlikely to be interest in automobile purchasing that the method 700 ceases, or returns to operation 702 to reinitialize parameters and assess whether the user meets a threshold likelihood of interest.

It will be understood that the applications, modules, routines, processes, threads, or other software components implementing the described method/process may be realized using standard computer programming techniques and languages. The present application is not limited to particular processors, computer languages, computer programming conventions, data structures, or other such implementation details. Those skilled in the art will recognize that the described processes may be implemented as a part of computer-executable code stored in volatile or non-volatile memory, as part of an application-specific integrated chip (ASIC), etc.

As noted, certain adaptations and modifications of the described embodiments can be made. Therefore, the above discussed embodiments are considered to be illustrative and not restrictive.

1. A server for targeted messaging, comprising:
a network connection;
a processor coupled to the network connection; and
memory coupled to the processor and storing processor-executable instructions that, when executed by the processor, are to cause the processor to:
receive, via the network connection, geolocation data from a mobile device representing location of the mobile device over a time window;
determine, from the geolocation data, that the mobile device visited a monitored location;
detect occurrence of an activity at the monitored location based on the geolocation data, wherein the activity is detected based on a time determined between a departure from the monitored location and a return to the monitored location;
determine, based on the activity, a propensity score associated with the mobile device and the monitored location;
determine, based on the propensity score, a message associated with the monitored location; and
send, via the network connection, the message to the mobile device.

2. (canceled)

3. The server of claim 1, wherein the activity is detected further based on velocity data obtained from the geolocation data between the departure and the return.

4. The server of claim 1, wherein the activity is detected further based on an arrival at the monitored location prior to the departure, the departure and the return occurring within less than a threshold time, and a further departure from the monitored location.

5. The server of claim 4, wherein the activity is detected further based on identification, from the geolocation data, of a second departure and a second return occurring between the arrival and the further departure.

6. The server of claim 1, wherein the instructions, when executed, are to cause the processor to determine the propensity score by further determining a count of visits to the monitored location.

7. The server of claim 1, the instructions, when executed, are to cause the processor to determine the propensity score by further determining a count of visits to locations in a same class as the monitored location.

8. The server of claim 1, wherein the monitored location includes a car dealership and the activity includes a test drive.

9. The server of claim 1, further comprising a data store that includes user data, and wherein the mobile device is associated with a registered user, and wherein the instructions, when executed, are to cause the processor to obtain stored user data from the data store associated with the registered user and to determine the propensity score based on the activity and the stored user data.

10. The server of claim 9, wherein the stored user data includes financial data associated with the registered user.

11. A method of targeted messaging comprising:
receiving geolocation data from a mobile device representing location of the mobile device over a time window;
determining, from the geolocation data, that the mobile device visited a monitored location;
detecting occurrence of an activity at the monitored location based on the geolocation data, wherein the activity is detected based on a time determined between a departure from the monitored location and a return to the monitored location;
determining, based on the activity, a propensity score associated with the mobile device and the monitored location;
determining, based on the propensity score, a message associated with the monitored location; and
sending the message to the mobile device.

12. (canceled)

13. The method of claim 1, wherein the activity is detected further based on velocity data obtained from the geolocation data between the departure and the return.

14. The method of claim 1, wherein the activity is detected further based on an arrival at the monitored location prior to the departure, the departure and the return occurring within less than a threshold time, and a further departure from the monitored location.

15. The method of claim 14, wherein the activity is detected further based on identification, from the geolocation data, of a second departure and a second return occurring between the arrival and the further departure.

16. The method of claim 11, wherein determining the propensity score further includes determining a count of visits to the monitored location.

17. The method of claim 11, wherein determining the propensity score further includes determining a count of visits to locations in a same class as the monitored location.

18. The method of claim 11, wherein the monitored location includes a car dealership and the activity includes a test drive.

19. The method of claim 11, wherein the mobile device is associated with a registered user, and wherein determining a propensity score is further based on stored user data associated with the registered user.

20. The method of claim 19, wherein the stored user data includes financial data associated with the registered user.

21. The server of claim 1, wherein the activity is detected based on sensor data sent to the server by the mobile device.

22. The method of claim 11, wherein the activity is detected based on sensor data sent to the server by the mobile device.
